(19) United States
(12) Patent Application Publication
(10) Pub. No.: US 2012/0032492 A1
(43) Pub. Date: Feb. 9, 2012

(54) Tow Trailer

(76) Inventor: Jeffrey R. Garibotti, Hinsdale, IL (US)

(21) Appl. No.: 13/179,265

(22) Filed: Jul. 8, 2011

Related U.S. Application Data
(60) Provisional application No. 61/363,189, filed on Jul. 9, 2010.
(60) Provisional application No. 61/394,733, filed on Oct. 19, 2010.

(51) Int. Cl. B60P 1/28

(52) U.S. Cl. 298/17.5

(57) ABSTRACT

A tow trailer includes a bed portion, a pair of upright members, an axle that runs underneath the bed portion, and a pair of swing arms, each pivotally connected at one end to one of the upright members and pivotally connected at another end to the axle. The tow trailer further includes a pair of wheels coupled to one another through the axle, and a brace member, affixed to the bed portion near a longitudinal side of the bed portion. The brace member can be locked to a corresponding swing arm via a locking member.

### RELATED APPLICATIONS

This application claims the benefit of U.S. Provisional Application No. 61/363,189, filed on Jul. 9, 2010, and which is herein incorporated by reference in its entirety.

### BACKGROUND

Various tilting trailers have previously been designed for increasing ease of loading and unloading cargo. Typical tilting trailers are configured with an axle that runs below the tilting bed and its axis running through the wheels of the trailer. This trailer configuration enables the bed to tilt around the axle. Depending on the position of the wheels relative to the length of the bed and the height of the wheel axis, the tilting angle can be undesirably steep. When a low tilt angle is desirable, the trailer wheels are typically positioned closer to the front end of the bed toward the towing hitch which is designed to securely connect to a tow vehicle. Moreover, to effectuate the tilt the front end of the trailer bed is typically raised by an individual or a tilt controlling mechanism. A few patent publications incorporating such trailer configurations are discussed below.

One such tilting trailer is disclosed within U.S. Patent Application No. 2009/0234375 A1 to Fred W. Mann, published on Dec. 31, 2009. The disclosed trailer includes a tilting bed and a hydraulic tilt control. The tilt control includes piston-and-cylinder units for restraining or cushioning the pivotal movement of the bed between a transport mode and a tilt mode. A flow control valve provides fine control of the rotation of the bed when equipment is placed thereon and the trailer converts to a transport mode with the bed level. U.S. Patent Publication No. 2009/0234375 A1 is incorporated herein by reference for at least the purpose of giving context to the present invention.

U.S. Patent Publication No. 2005/0200190 A1 to Charles J. Nye JR., published on Sep. 15, 2005, discloses a dump trailer that hitches to a tow vehicle and easily tilts to a dump position when the tow vehicle is backed up toward the dump trailer. The dump trailer has a tow bar assembly that is pivotally mounted on the front end of the trailer and pushes the body of the trailer to a tilted position when the tow vehicle backs up. The tow bar assembly includes an auxiliary wheel, allowing the trailer to be maintained in its horizontal position when not hitched to a tow vehicle. Also included is a work tray that is mounted on the handlebar of a small lawn trailer. An elevation sub-structure is also provided for larger utility trailers, which raises the trailer body so that the dump trailer can be brought to a 45-degree tilt angle for optimal dumping. U.S. Patent Publication No. 2003/0155267 A1 is incorporated herein by reference for at least the purpose of giving context to the invention.

However, these prior tow trailers require that the body of the dump trailer be forced into a substantial vertical orientation to raise the front end of the trailer bed and lower its rear end or a titling control mechanism. Thus, it is desirable to have a tow trailer with a tilting bed that requires no such exaggerated tilting system and no tilting control mechanism. It is further desirable that a tow trailer has low ground clearance and sturdy drive-on beds to accommodate transportation as well as ease of loading and unloading of drivable cargo, such as vehicles or other drivable equipment.

### SUMMARY

Disclosed herein are improved apparatuses and devices directed to a tow trailer having a tilting load carrying bed.

In one embodiment, a tow trailer includes a bed portion, a pair of upright members, an axle that runs underneath the bed portion, and a pair of swing arms, each pivotally connected at one end to one of the upright members and pivotally connected at another end to the axle. The tow trailer further includes a pair of wheels coupled to one another through the axle, and a brace member, affixed to the bed portion near a longitudinal side of the bed portion. The brace member can be locked to a corresponding swing arm via a locking member.

In another embodiment, the tow trailer includes a guide member, affixed to one of the upright members, having a U-shaped configuration with an open side facing a front end of the bed portion.

In another embodiment, the tow trailer includes a wheel arm member, pivotally coupled to one of the swing arms and pivotally coupled to the axle. The arm member serves to minimize lateral movements of the pair of swing arms relative to the pair of upright members.

### BRIEF DESCRIPTION OF THE FIGURES

To understand the invention, it will now be described by way of embodiments, with reference to the accompanying figures in which:

FIG. 1 illustrates a perspective view of a tow trailer in accordance with a preferred embodiment of the invention;

FIG. 2 illustrates a perspective view of the tow trailer of FIG. 1, with the bed tilted in a loading or unloading position, in accordance with a preferred embodiment of the invention;

FIG. 3 illustrates a side perspective view of the tow trailer of FIG. 1;

FIG. 4 illustrates a side perspective view of the tow trailer of FIG. 1 with the trailer wheels removed;

FIG. 5 illustrates a top perspective view of the tow trailer of FIG. 1;

FIG. 6 illustrates an elevated side perspective view of the tow trailer of FIG. 1 with the wheels removed and showing a wheel axle connected to a swing arm of the tow trailer.

FIG. 7 illustrates an elevated side perspective view of the tow trailer of FIG. 1 having a guide for the swing arm in accordance with a preferred embodiment of the invention;

FIG. 8 illustrates a top view of the swing arm guide attached to an upright member; and

FIG. 9 illustrates an elevated side perspective view of a swing arm coupled to a wheel axle via a rubber torsion arm suspension member in accordance with a preferred embodiment of the invention.

Illustrative and exemplary embodiments of the tow trailer are described in further detail below with reference to and in conjunction with the figures.

### DETAILED DESCRIPTION

The invention is defined by the appended claims. This description summarizes some aspects of the present embodiments and is not intended to limit the invention defined by the claims.

While the invention may be embodied in various foil is, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

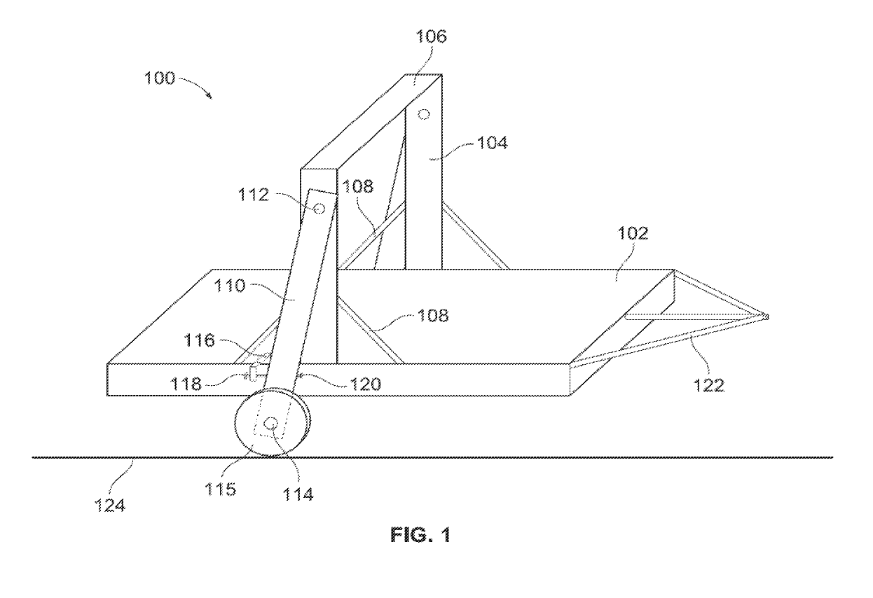

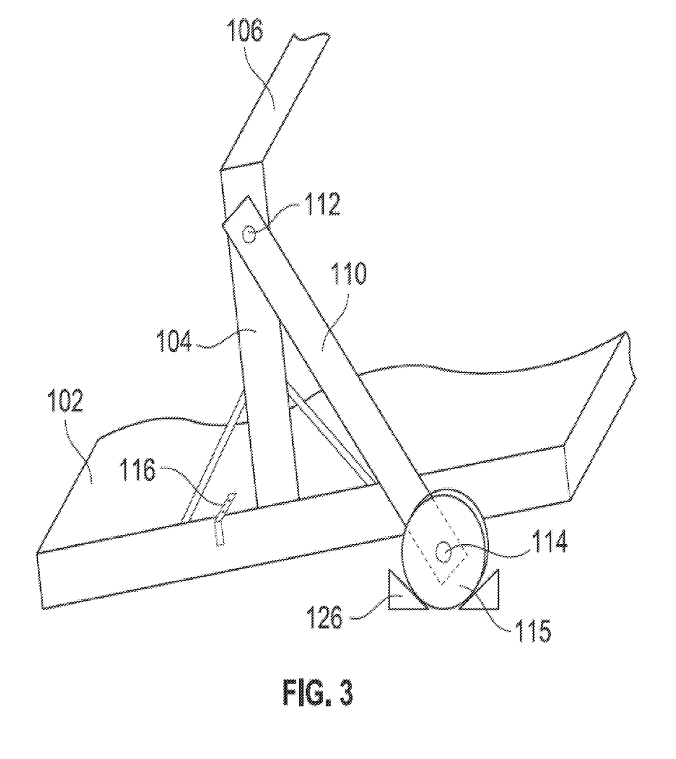

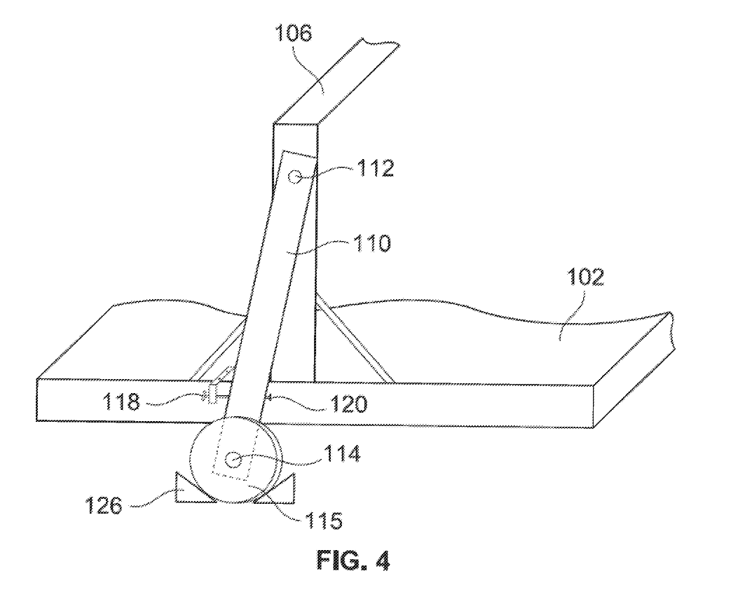

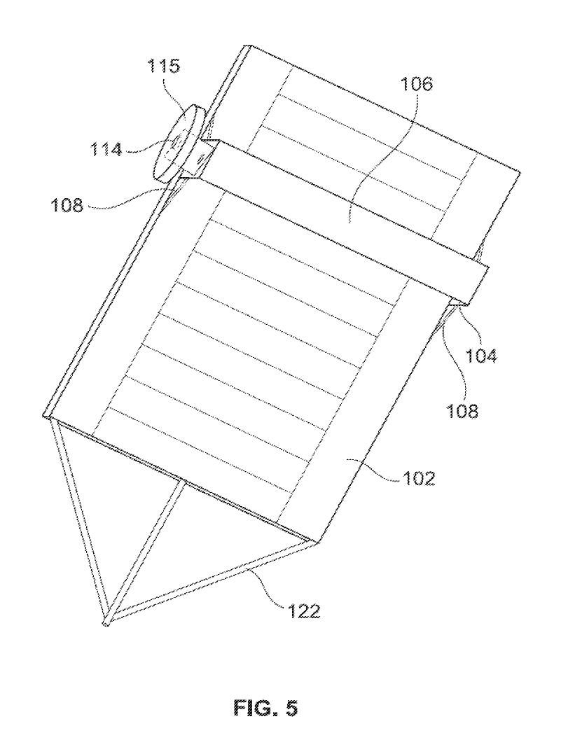

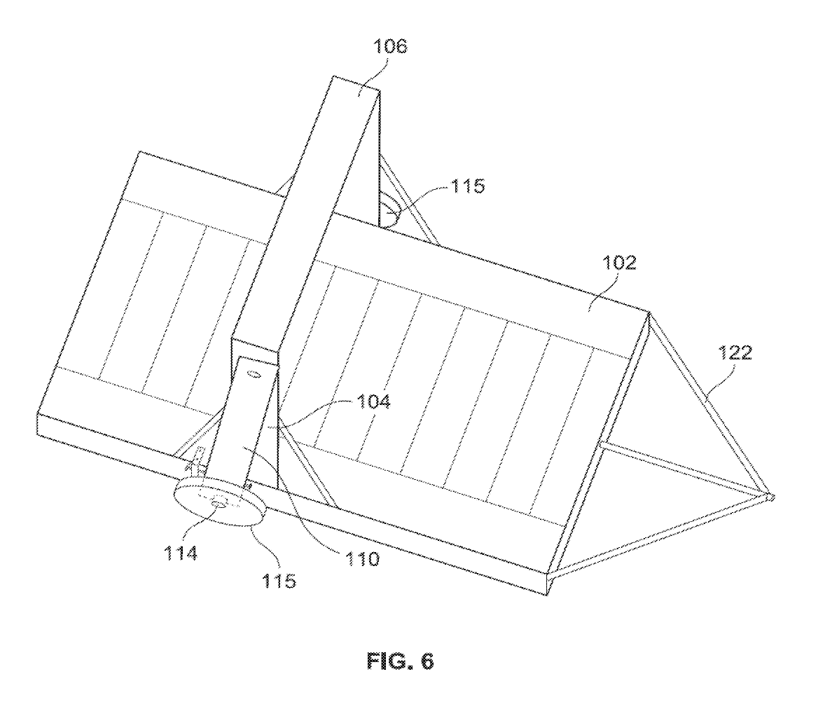

This invention is directed to a tow trailer with a tilting bed. With reference to FIGS. 1-6, the tow trailer constructed in accordance with the invention is indicated generally by the reference numeral 100. Like reference numerals designate like or corresponding parts throughout the various figures.

Tow trailer 100 includes a main frame or bed portion 102, which is configured as a load carrying portion, and a forwardly extending hitching portion 122, having means for attachment to a towing vehicle. Tow trailer 100 includes a pair of upright members 104, each one affixed to one of the two longitudinal sides of bed portion 102 and extending substantially vertically. The two upright members 104, which are preferably welded to bed portion 102, are connected at their respective top ends to a cross member 106. Alternately, the upright members 104 may be affixed to bed portion 102 by any suitable means, such as bolt-and-nut combinations and the like. Tow trailer 100 further includes slanted members 108, affixed to both upright members 104 and bed portion 102 to strengthen their attachments to one another.

Pivotally attached to each of the uprights members 104 is a swing arm 110, which rotates about a pivot 112. Each of the swing arms 110 is further configured to pivot about an axle 114 of a wheel 115. As such, each swing arm 110 has two pivoting axes, one pivoting axis located on a corresponding upright member 104 and another pivoting axis coinciding with a rotating axis of corresponding wheel 115. The pair of wheels 115 is coupled to one another by axle 114, which runs underneath bed portion 102.

Bed portion 102 further includes a brace 116, which can be affixed to the cargo loading surface or a longitudinal side of bed portion 102. Preferably, tow braces 116 are provided, one on each longitudinal side of bed portion 102. Each one of braces 116 and each one of swing arms 110 have through holes that can accommodate therethrough a locking member or pin 118 so as to keep one brace 116 and one swing arm 110 locked to one another during transportation of cargo. Alternately, braces 116 and corresponding swing arms 110 can be locked to one another in any suitable manner

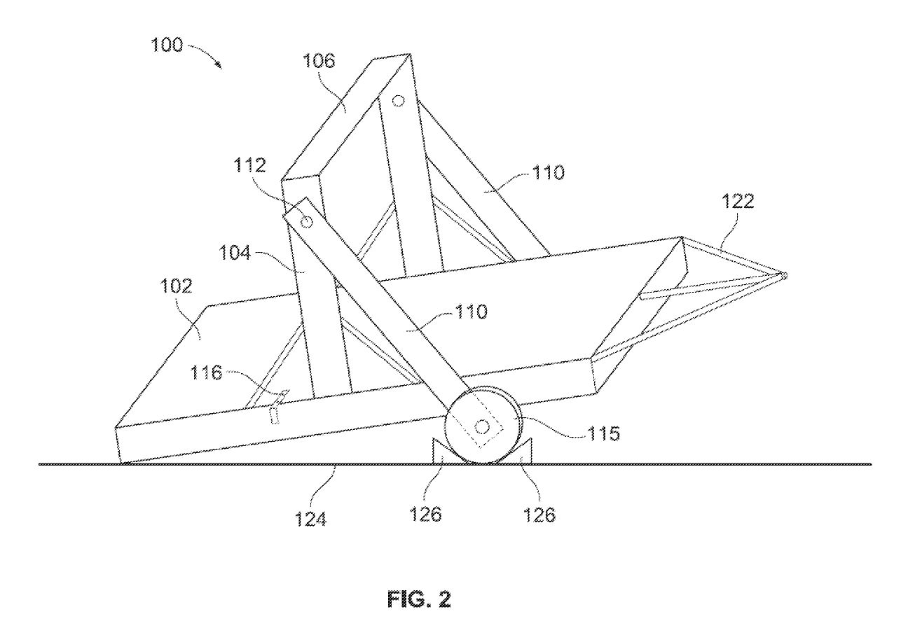

Operation

Whereas FIG. 1 shows tow trailer 100 in a transport mode, FIG. 2 shows tow trailer 100 in a loading and/or unloading mode with the rear end of bed portion 102 resting on a ground surface 124. With reference to FIGS. 2-6, a tilting action of bed portion 102 is initiated by blocking the movements of wheels 115 by placing them between chocks or wedges 126, removing pin 118 that locks swing arm 110 to bed portion 102 via brace 116, and backing the towing vehicle (not shown).

During the backing process or operation, blocked tow trailer wheels 115 stay stationary which leads or forces bed portion 102 to move backward with respect to wheels 115 and swing arms 110 to swing or to move forward ahead of upright members 104. The backing process and tilting of bed portion 102 can end once the rear end of bed portion 102 makes contact with ground surface 124, thereby facilitating a drive-on or a drive-off of a vehicle or loading or unloading of equipment.

To raise bed portion 102 into a transportation mode, wheels 115 are blocked from moving, if not already, by placing between chocks 126 and pulling forward tow trailer 102 via the tow vehicle. During the pull, bed portion 102 raises off ground surface 124 and swing arms 110 swing or move backward toward the rear end of bed portion 102, preferably past upright members 104. Once swing arms 110 get sufficiently near or come in contact with corresponding braces 116, pins 118 can be inserted through corresponding through holes of both braces 116 and swing arms 110 to lock them together.

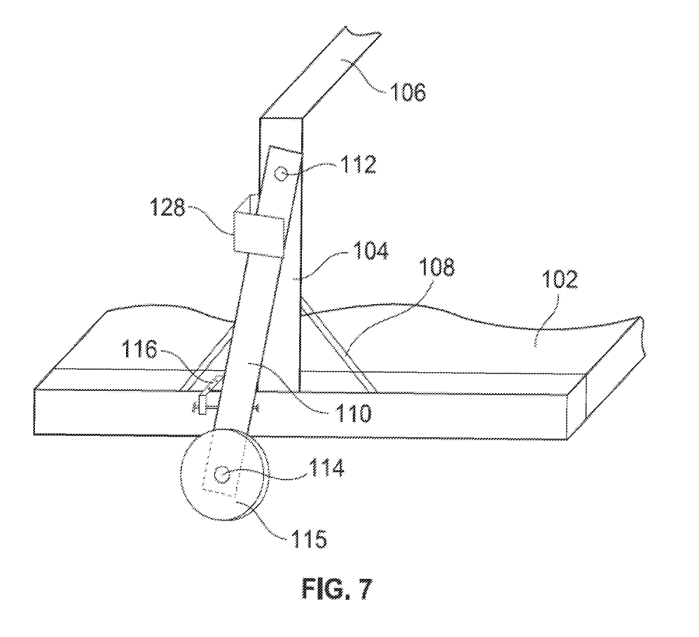

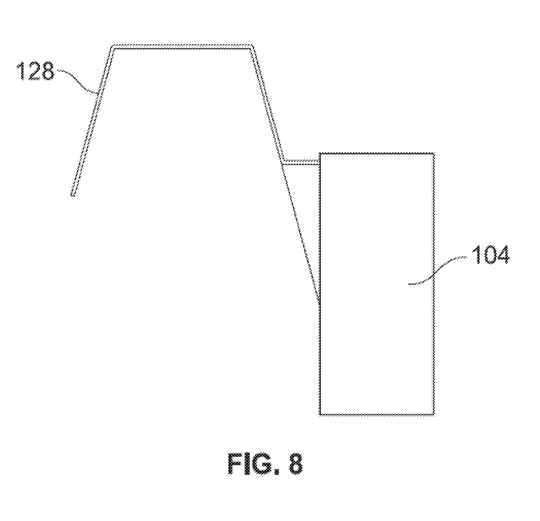

Referring to FIGS. 7 and 8, in one particular embodiment tow trailer 100 includes a guide member 128, which can be securely affixed to one of the upright members 104 at a position between that of pivot 112 and that of bed portion 102. Guide member 128 is configured to have a U shape with the open side facing the front end of bed portion 102. Alternately, guide member 128 may have a trapezoidal shape with a missing side being closest to the front end of bed portion 102.

As such, during the pull operation which raises bed portion 102 off ground surface 124, while moving backward relative to upright members 104, one of the swing arms 110 enters guide member 128, thereby minimizing lateral movements of swing arms 110 relative to upright members 104.

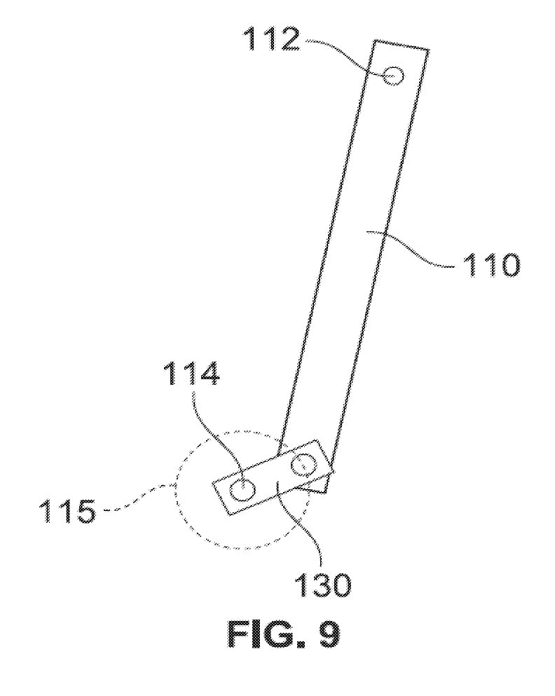

As discussed above, each of swing arms 110 is configured to pivot about axle 114 of the wheel 115. As shown in FIG. 9, one of swing arms 110 is rotatably coupled to a wheel arm member 130, which in turn is configured to pivot about axle 114. Wheel arm member 130 is preferably configured as a shock absorber to reduce the effects of tow trailer 100 traveling over rough ground surfaces. In one particular embodiment, wheel arm member 130 is a rubber torsion arm suspension.

While a preferred embodiment of the invention have been described in detail, it will be appreciated by those skilled in the art that various modifications and alternatives to those details could be developed in light of the overall teachings of the disclosure. Accordingly, the particular features and arrangements disclosed are meant to be illustrative only and not limiting as to the scope of the invention which is to be given the full breadth of the appended claims and any equivalent thereof.

What is claimed is:

1. A tow trailer, comprising;
a bed portion;
a pair of upright members, each affixed to the bed portion;
an axle that runs underneath the bed portion;
a pair of swing arms, each pivotally connected at one end to one of the upright members and pivotally connected at another end to the axle;
a pair of wheels coupled to one another through the axle; and
a brace member, affixed to the bed portion near a longitudinal side of the bed portion, wherein the brace member can be locked to a corresponding swing arm via a locking member.

2. The tow trailer of claim 1, further comprising:
a guide member, affixed to one of the upright members, having a U-shaped configuration with an open side facing a front end of the bed portion.

3. The tow trailer of claim 1, further comprising:
a guide member, affixed to one of the upright members, having a trapezoidal shape with an open side facing a front end of the bed portion.

4. The tow trailer of claim 1, further comprising:
a wheel arm member, pivotally coupled to one of the swing arms and pivotally coupled to the axle, wherein the arm member serves to minimize lateral movements of the pair of swing arms relative to the pair of upright members.

5. The tow trailer of claim 4, wherein the wheel arm member is made of rubber, thereby operating as a rubber torsion arm suspension.

6. The tow trailer of claim 1, wherein each of the pair of upright members is affixed to a longitudinal side of the bed portion.
